(19) United States
(12) Patent Application Publication
(10) Pub. No.: US 2008/0243642 A1
(43) Pub. Date: Oct. 2, 2008

(54) System And Method For An Intellectual Property Marketplace

(75) Inventor: Andrew T. Ramer, Chicago, IL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Ocean Tomo, LLC, Chicago, IL (US)

(21) Appl. No.: 12/059,685

(22) Filed: Mar. 31, 2008

Related U.S. Application Data
(60) Provisional application No. 60/909,371, filed on Mar. 30, 2007.
(60) Provisional application No. 60/910,194, filed on Apr. 4, 2007.

(51) Int. Cl. G06Q 30/00

(52) U.S. Cl. 705/27; 705/37; 705/35; 705/1

(57) ABSTRACT

A method for transacting intellectual property includes the steps of receiving an executed document transferring an intellectual property right to an undefined party; receiving one or more offers for the intellectual property right; determining a winning party based on the one or more received offers; and releasing the executed document to the winning party. The method may further include placing the executed document in a data room for review by a potential acquirer prior to receiving one or more offers for the intellectual property night. The data room may be an on-line data room and include information for the potential acquirer to conduct due diligence of the intellectual property right. The intellectual property transaction may be conducted in a live or electronic auction. The intellectual property right may be submitted through an online submission form and an automated qualification system may classify the intellectual property right.

### CROSS REFERENCE TO RELATED APPLICATIONS

This application claims the benefit of U.S. Provisional Application Nos. 60/909,371, filed Mar. 30, 2007, and 60/910,194, filed Apr. 4, 2007, the entire disclosures of which are incorporated in their entirety herein by reference thereto.

### BACKGROUND OF THE INVENTION

1. Field of the Invention

The invention relates to systems and methods for transacting intellectual property.

2. Background Art

Conventionally, intellectual property has been transacted through protracted, bilateral negotiations between a potential seller and a potential buyer. The shortcomings of this approach are numerous. Intellectual property transactions are notorious for incurring high transaction costs, producing highly uncertain outcomes, taking extended periods of time to complete, and exposing both parties to potential litigation risks. In addition, as the market for transacting IP is private, it is often the case that potentially interested parties in the particular intellectual property assets are not aware they are available for purchase, or when they do know they are available, it is extremely difficult to assess the value of such assets due to a lack of public information about comparable transactions. As a result, intellectual property is transacted infrequently or in very private settings, resulting in poor liquidity and pricing uncertainty.

Because intellectual property is a legally created intangible asset, and because different purchasers will usually have different needs and reasons which fuel their reasons for purchasing, the scope of potential terms for a given transaction is enormous. This breadth of possibility is in large part responsible for the high transaction costs and lengthy negotiation and transaction times associated with intellectual property transactions. Parties to a typical intellectual property transaction must consider, for example, how to address existing or future licenses, sub-license rights, encumbrances, pending or past litigations, field of use rights, security interests, joint development agreements, royalty rates, representations, warranties, indemnifications, and other questions related to the terms under which the intellectual property rights will be transferred. Almost no two intellectual property transactions are alike, and the extent of details to be agreed often results in extended and expensive negotiation periods.

In the case of certain intellectual property, such as patents, constraints on the free flow of information discourage initiation and completion of transactions. A would-be buyer, for example, may hesitate to consider a patent acquisition opportunity for fear of creating potential exposure to a finding of willful infringement. On the other hand, a sizable portion of the patent's actual or expected value may be obscured by confidential rights or licenses, and sellers are frequently adverse to risk disclosure until transaction terms appear to be reasonably settled. These hindrances to the flow of information between buyers and sellers, coupled with the wide scope of potential transaction terms, create complex interactions between negotiation and diligence processes, resulting in an inefficient (and in many cases imbalanced) market for intellectual property.

### BRIEF SUMMARY OF THE INVENTION

A system and method for conducting an intellectual property transaction with non- or pre-negotiated terms is presented. In one embodiment, a seller outlines terms for sale of intellectual property. The seller executes binding agreements committing to transfer intellectual property rights to an unidentified party according to the terms of sale. The terms of sale are diligenced and reviewed by interested parties. One or more of the interested parties make offers to purchase the intellectual property. In one embodiment, the offers are binding. One of the offering parties is selected and made party to the terms of sale. The intellectual property transaction may then be completed, perfected, recorded with the appropriate offices, and so on.

In a further embodiment, the intellectual property transaction is conducted in a live or electronic auction. The terms of sale of the intellectual property outlined by the seller are made available in a physical or virtual data room. Interested parties can place bids on the intellectual property offering using a variety of mechanisms which include, but are not limited to live bidding, phone bidding, online bidding, completing an absentee or commission bid in written, electronic, or voice recorded communication in advance of the auction. The winning bidder complies with the terms of his bid, which can include making payment and providing relevant information, and the executed binding agreements are completed so that the intellectual property is transferred to the winning bidder. Because the terms of the transaction are non-negotiated and the auction date may be publicly announced in advance, the amount of time required to complete a transaction can be significantly reduced.

To facilitate the exchange of information, contractual agreements may be put into place prohibiting facts related to the intellectual property offering from being used as evidence in a judicial proceeding. In one embodiment, sellers and potential buyers sign agreements agreeing not to use another seller's or buyer's participation in the potential transaction as evidence of actual notice of intellectual property rights. In another embodiment, sellers and potential buyers agree to be bound by published condition or terms surrounding the auction, where such terms include such a protective provision. In another embodiment, sellers and buyers will acknowledge such a provision either individually or as part of a large set of conditions, by some electronic approval or consent method. Parties who have not entered into such an agreement may be excluded from participating in, or even reviewing material related to, the potential transaction. The scope of such an agreement may extend to a single transaction, a list of designated transactions, or any transaction meeting particular requirements. By limiting the possibility of a willfulness finding based on marketplace participation, the present risk of examining and potentially purchasing intellectual property can be reduced, resulting in higher participation in such transactions.

A method for accepting intellectual property submissions for consideration for sale in an intellectual property auction is also presented. The submissions are provided through an online submission form. The method includes receiving a submission including an intellectual property right for sale; having the submission download to an electronic repository; and using an automated qualification system that classifies the intellectual property right according to a variety of factors. In one embodiment, the method further includes accepting to sell the intellectual property right at the auction if the intellectual property right has a classification that meets a pre-determined set of criteria. In one embodiment, the automated qualification system includes a rating system that provides a rating of the salability of the intellectual property right. In one embodiment, the method further includes accepting to sell the intellectual property right at the auction if the intellectual property right has a rating above a given threshold. The accepted intellectual property right is offered for sale at the auction.

### BRIEF DESCRIPTION OF THE FIGURES

FIG. 1 illustrates a method for conducting an intellectual property transaction, according to one embodiment of the present invention.

FIG. 2 illustrates an exemplary user interface for an online data room, according to one embodiment of the present invention.

FIG. 3 illustrates an exemplary user interface for an online data room, according to another embodiment of the present invention.

FIG. 4 illustrates an example computer system, in which the methods presented herein can be implemented as computer readable code.

### DETAILED DESCRIPTION OF THE INVENTION

The invention relates to systems and methods for transacting intellectual property. According to various embodiments of the present invention, intellectual property (“IP”) can include patents, brands, trademarks, domains, copyrights, endorsement rights, naming rights, music and film rights, trade secrets, know-how, prototypes, designs, source code, and other intangible assets which may or may not be protected at present and in the future under applicable law. In one embodiment, one or more intellectual property rights (herein referred to as “intellectual property assets” or simply “intellectual property”) are offered as a lot or grouping available for purchase in an auction.

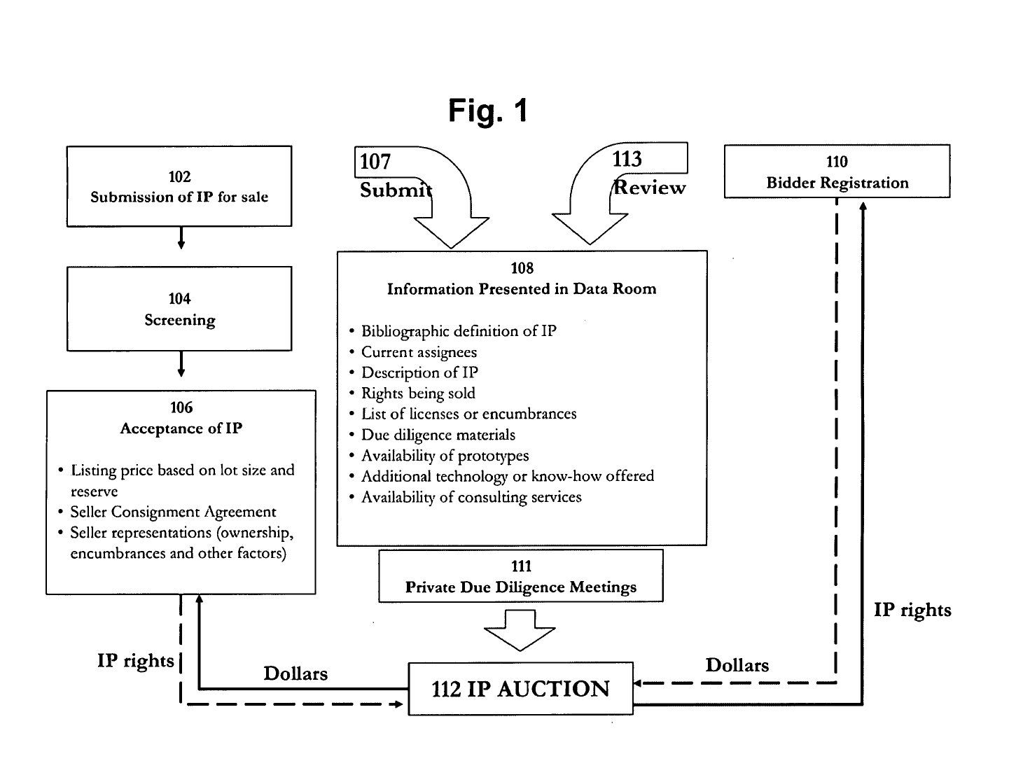

FIG. 1 illustrates a method for conducting an intellectual property transaction, according to one embodiment of the present invention. In one embodiment, intellectual property is transacted in an auction, which can be organized live, real time or using another competitive format. Intellectual property is submitted 102 for consideration. Intellectual property can be submitted 102, for example, as a list of patent numbers, a written description of the intellectual property, a copy of a recording, a general asset list, a trade secret under non-disclosure agreement, or any other means, written, recorded, verbal or otherwise which would convey the intellectual property being submitted, and so on. In one embodiment, intellectual property is submitted 102 using an online submission form.

The submitted intellectual property is screened 104. A facilitator of intellectual property transactions (for example, an auction house or an entity qualified to conduct an IP review) can evaluate the intellectual property to determine if it is suitable for sale. Various criteria can be applied to determine the relative value, quality, and any other factor relating to the salability of the submitted intellectual property. For a patent submission, for example, the auction house may consider many different factors including, but not limited to the technology area of the patent, the strength and number of the claims, the filing date, and so on. For trademarks, the auction house might consider such factors as the market penetration and knowledge of the trademarks or corresponding brand, the length of time it was in the marketplace, the legal status of the trademark, and other factors. The auction house may also employ any number of quantitative tools, including software, algorithms, macros, spreadsheets, and otherwise to evaluate the intellectual property.

Based on the screening 104, some of the submitted 102 intellectual property may be rejected for inclusion into the auction or competitive bidding environment and other intellectual property may be accepted 106. The potential seller of accepted 106 intellectual property is offered a place in the auction. The seller executes certain documents as part of the acceptance 106.

In one embodiment, the seller executes a consignment agreement, or other document or agreement serving the same or similar purpose, authorizing the auction house, or receiving entity, to act as the exclusive consignor for some specified period of time. In one embodiment, the auction house or receiving entity will act as the non-exclusive consignor. The consignment agreement, or other similar agreement serving the same purpose, outlines the terms of the arrangement between the auction house and the seller, and typically includes various representations by the seller. For example, a seller of accepted 106 intellectual property may be required to represent that he is the exclusive owner of the intellectual property with the right to transfer title free of encumbrances. In one embodiment, there will be multiple sellers which together comprise exclusive ownership of the intellectual property. The seller may also be required to covenant that he will not transfer, sell, or encumber in any manner whatsoever, the intellectual property during the term except by mechanisms specified in the consignment, will not issue any new licenses to the intellectual property, will pay maintenance fees during the term, and will fulfill any other requirements or covenants of the agreements. The seller may also be required to represent and warranty other necessary terms, and consent to the terms and condition of the auction, and other provisions. In another embodiment, the seller will execute documents or agree with the auction house in some binding fashion to auction the specific assets, but where the agreement(s) executed are not specifically a “consignment”.

The consignment agreement may also include terms for payment to the auction house. For example, the consignment agreement may require the seller to pay certain listing fees or other fees in conjunction with placing their intellectual property into the auction. The amount due as listing fees can depend on a variety of factors, including the number of items (i.e. patents, trademarks, domains, and so on) included in each lot, the number of lots offered for auction, the setting of a reserve price for a lot, the amount of the reserve price for a lot, the length of the consignment's term, the single or multiple auction commitment from a seller, and other factors. In one embodiment, the listing fees are calculated as a percentage of the reserve price. Other fees may be due from the seller contingent on the sale of the lot. For example, a seller may agree to pay a fixed or scaling percentage based on the price for which a lot sells. In one embodiment, the contingent seller fee can be based on a license royalty stream or transfer of some form of consideration of the asset which does not constitute an outright sale. In one embodiment, a consignment agreement may specify a first amount owed to the auction house if the lot sells at auction and a second amount owed to the auction house if the lot sells during the term but not at the auction. The consignment agreement may also authorize the auction house to collect a fee from buyers. A single consignment agreement may be used to consign multiple lots with the same or different sellers. A consignment agreement for a lot including intellectual property owned by multiple parties can also specify how the proceeds from the sale of the lot should be divided among the various parties. In one embodiment, the consignment agreement includes a non-use provision that specifies that the seller will not use another party's participation in the auction process as evidence in any judicial or administrative proceeding (e.g., court, customs, or mediation proceedings). For example, the seller may desire to use another party's participation in the auction process as evidence of willful infringement; however, as a consequence of the non-use provision in the consignment agreement, the seller will be contractually prohibited from doing so. In one embodiment, the consignment will be for the auction or sale of licenses, individually or as a group, covenants, or other rights which are not an outright sale, which convey a particular benefit or consideration to the winning bidder.

In one embodiment, acceptance 106 of the intellectual property can include binding execution of documents for transferring the intellectual property rights to another party. These documents can be embodied as an intellectual property sale agreement. As used herein, an “intellectual property sale agreement” can be any set of documents which facilitate the transfer of any current or future rights in intellectual property, either by themselves, or in conjunction with other documents. For example, the intellectual property rights for transfer using the intellectual property sale agreement may include license rights, ownership rights pursuant to an outright sale of the intellectual property right, a covenant not to sue, and an option to purchase a license right or ownership right. The intellectual property sale agreement specifies the terms and conditions offered in the transaction by the seller. According to various embodiments, at the time of execution by the seller, the intellectual property sale agreement does not specify a particular buyer or assignee. For example, a space for the assignee of the intellectual property can be left blank. The intellectual property sale agreement (and other assignment documents) can be held in escrow by the auction house, or by a third party affiliated or unaffiliated with the auction house. After payment for the lot has been received (and/or other conditions have been met), the intellectual property sale agreement, and/or other documents facilitating transfer, can be completed with the purchasing entity's information and/or released to the buyer. In one embodiment, the consignment agreement includes a provision that grants the auction house authority to complete and/or release the sale agreement to the buyer.

The intellectual property sale agreement can also include representations and warranties regarding the intellectual property, such as details of licenses, encumbrances, and other exclusions, as well as legally recordable title documents such as recordable patent assignments.

In one embodiment, acceptance 106 of the intellectual property can include completion of one or more questionnaires outlining the details of the intellectual property. For example, a diligence questionnaire can be used to highlight the usefulness of the intellectual property for the marketplace, descriptions of the intellectual property, details regarding existing licenses, litigation history, availability of prototypes and so on.

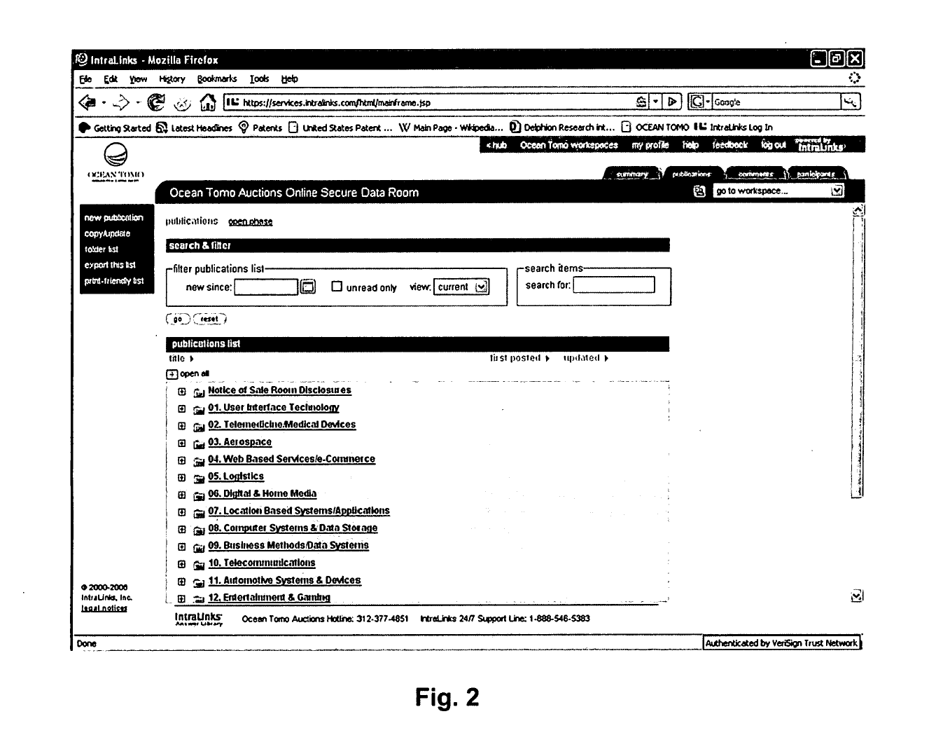

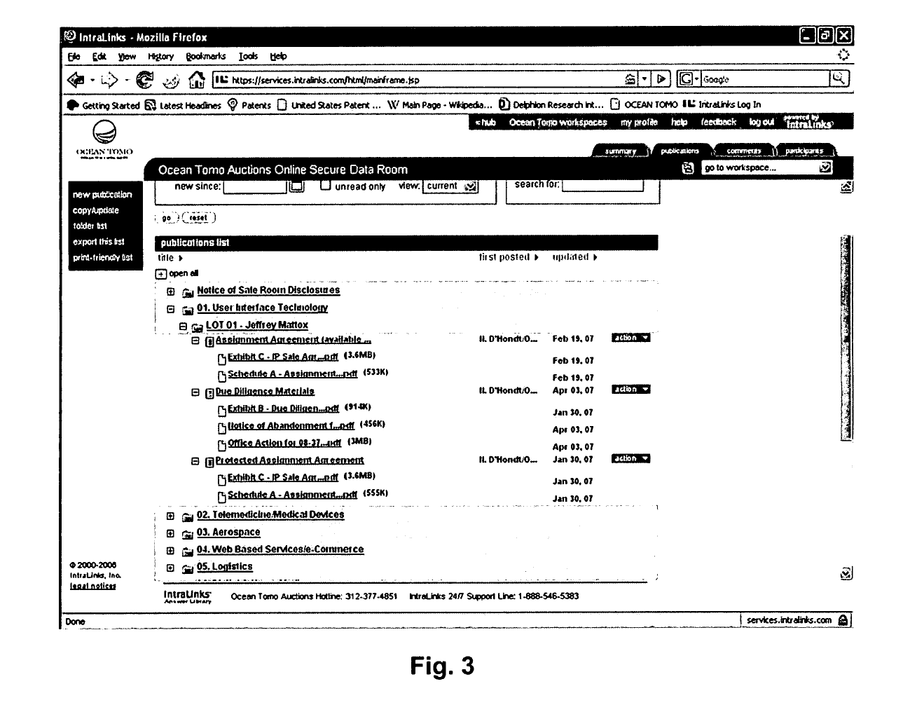

Information regarding the intellectual property offering is submitted 107 and presented 108 in a data room. The data room, online or tangible, can contain, for example, a copy of the intellectual property sale agreement, assignment(s), diligence questionnaire, file histories, copies of licenses, assignments in the chain of title, and other information which may be useful to prospective bidders. FIGS. 2 and 3 illustrate exemplary graphical user interfaces for an on-line data room, in accordance with embodiments presented herein. According to one embodiment of the present invention, the data room may contain redacted versions of license agreements, or redacted versions of the intellectual property sale agreement to protect the rights of the seller. The data room can be hosted by the auction house, or by a third-party provider. In one embodiment, the particular license or encumbrance details may be deemed confidential material to a seller, and the seller may be unable to disclose confidential material except under non-disclosure. In this instance, the seller can place a copy of an agreeable non-disclosure agreement in the data room for registered bidders or other parties to review and execute. Once the non-disclosure agreement is executed, the license or other confidential material will be shared.

In another embodiment where sellers are prohibited from sharing the details of a license under non-disclosure, the buyer will submit a written list of companies or other entities either directly to the seller or through the auction company, and the seller will confirm only those parties that are not licensees and where no confidentiality concerns apply.

Interested parties register 110 as bidders for the intellectual property auction. In one embodiment, registering 110 as a bidder includes executing an agreement, or consent in some verifiable and bound manner, not to use another party's participation in the auction process as evidence of willful infringement. Registering as a bidder can also include agreeing to pay the auction house certain fees. The auction house may receive fees for a party to be allowed to bid at the auction, fees based on whether or not the party wins any bidding at the auction, and/or fees based on the amount of winning bids at the auction. For example, the auction house may charge the winning bidder a fixed or sliding percentage of the winning bid amount at auction. In one embodiment, by registering 110 to bid a party may also agree to pay a percentage of the purchase price of lots offered for sale at auction, whether or not such sale actually occurs at the auction. According to one embodiment, bidder registration 110 allows a party to bid on a lot at the intellectual property auction, but does not obligate the party to bid on or purchase any lot. In one embodiment, bidder registration 110 does not obligate the party to bid on any lot, but does obligate the party to purchase any lot for which they are the winning bidder.

Registered bidders are granted access to the data room. In one embodiment, only parties agreeing to the terms of bidder registration are granted access to the data room. In another embodiment, provisioned access to the data room can be given to non-registered bidders. Via the data room, a registered bidder has the opportunity to anonymously review 113 the terms of sale and other information regarding the intellectual property offering. In one embodiment, a registered bidder can also request a private due diligence meeting 111 with the seller and/or inventor. In one embodiment, this due diligence meeting can be in the form of an online communication, email, instant messaging or otherwise, by phone, live, or any other method of live or electronic communication which serves the function of conveying to the registered or non-registered bidder the information they seek. In some cases, a seller may have additional information available to prospective buyers only under non-disclosure agreement. Non-disclosure agreements can be arranged on a party-by-party basis for buyers potentially interested in specific lots. In one embodiment, bidder registration includes an agreement not to disclose information available only to registered bidders.

Advantageously, registered bidders can perform due diligence on a lot without a commitment to buy. Because certain information is available only to registered bidders, the confidentiality of that information is protected. Moreover, multiple registered bidders (any of whom could ultimately choose to buy the lot) can perform due diligence on the same lot in parallel. By making the intellectual property offering information available to multiple parties at the same time, under the same or similar terms and conditions, transaction inefficiencies are reduced and the liquidity of the intellectual property market can be increased.

At a particular time and date (typically announced in advance), the intellectual property auction 112 is held. The intellectual property auction 112 can be held in either a physical or virtual location. According to various embodiments, bidding for a particular lot can be received in person, over the phone, by proxy, with an absentee instruction, over the internet, or by other electronic means. In one embodiment, a registered bidder is required to present a bank letter of guaranty or another form of credit in order to be authorized to bid to a certain value. In one embodiment, the registered bidder can provide a letter from the company bank or from a company representative identifying an amount up to which they are authorized to bid.

At the auction, one or more intellectual property lots are offered for sale to registered bidders. The intellectual property right(s) in a lot for sale may include, for example, license rights, ownership rights pursuant to an outright sale of the intellectual property right, a covenant not to sue, and an option to purchase a license right or ownership right.

The auction can be conducted using a variety of techniques. For example, the auction can be conducted according to the rules of an English auction, a Dutch auction, a silent auction, a sealed-bid auction, a Vickrey auction, and so on. The winning bidder is selected by the auctioneer based on the rules for the auction. The identity of the winning bidder is typically kept in confidence. In one embodiment, prospective bidders can register and bid during the auction itself.

If a lot is sold at auction, the buyer transfers payments to the seller (in some cases via the auction house) and the intellectual property rights are transferred to the buyer. (Intellectual property rights can be transferred to the buyer, for example by completing and/or releasing the intellectual property sale agreement to the buyer.) Advantageously, in one embodiment an intellectual property transaction takes place without negotiation of terms and without a post-negotiation diligence period. The terms of sale are put forth by the seller, and registered bidders have the opportunity to review those terms as-is, perform due diligence, submit written questions and requests, and make their bid at auction. Because terms have been settled and diligence performed in advance, the bidder and seller can be assured that after the winning bidder has been selected by the auctioneer, the substantive steps for the transaction have been accomplished. Such a process limits transaction costs and reduces the amount of time taken to transact intellectual property.

A significant barrier to a typical intellectual property transaction are the large fees which may be incurred before the feasibility of a sale can be reasonably determined. A broker for a conventional intellectual property transaction typically charges a high up-front fee in order to take an intellectual property offering to market. This up-front fee protects the broker against the possibility that the intellectual property will not be sold, but at the same time discourages many potential sellers from ever taking their intellectual property to market.

In various embodiments, contractual terms are put in place that allow an intellectual property broker (or auction house) to take a larger result-based fee (such as a commission) in exchange for a lower up-front fee. These terms allow the intellectual property broker to make an administrative and marketing investment in bringing an intellectual property offering to market even if these costs are not offset alone by the up-front fees. In one such embodiment, as part of the consignment agreement the seller agrees to sell his intellectual property at or above a specified reserve or reservation price. After executing such an agreement, the seller is contractually obligated to accept a bid (or offer) provided the reserve price has been met. This obligation protects the intellectual property broker from the risk that, after the intellectual property broker has made a marketing investment in the offering, unrealistic seller expectations will make a successful deal difficult to accomplish. In one embodiment, the auction house may sell or transfer the identified rights in the intellectual property below the reserve and make up the difference with the reserve price by taking a reduced commission. In one embodiment, sellers can lower the reserves during the auction or during the bidding on their particular lot.

Other techniques can also be used to protect the salability of intellectual property during the consignment term. For example, the consignment agreement can include provisions requiring the seller to meet with perspective buyers and pay all maintenance fees associated with the intellectual property, and/or prohibiting the seller from issuing any additional licenses, establishing new liens against the intellectual property, or encumbering the intellectual property in any manner whatsoever. Generally, the consignment agreement can include any number of affirmative or negative covenants that the seller will protect the value of the consigned intellectual property. In the case of an intellectual property auction, the consignment term may extend past the day of the auction for lots not sold at auction. Thus a seller may have an obligation to maintain his intellectual property in salable condition even after the auction date. By protecting the salability of intellectual property during the consignment term, the likelihood that the intellectual property broker can recoup any administrative or marketing investment is increased, thereby enabling the broker to take on more ambitious engagements.

Another major hindrance to conventional intellectual property transactions, particularly patent transactions, is the fear of participants of exposing themselves to potential liability for willful infringement. In one embodiment of the present invention, a marketplace is created with more limited potential for creating potentially damaging evidence with regard to willfulness. To facilitate the exchange of information, contractual agreements may be put into place prohibiting facts related to the intellectual property marketplace from being used as evidence in a judicial proceeding. The willfulness-protected marketplace could be limited to a few particular offerings (such as a specific intellectual property auction), or could extend indefinitely for ongoing activity in a continuous transactional environment. In another embodiment, one or more parties wishing to transact intellectual property could covenant not to assert willfulness claims against another participating party (or, optionally, any participating party). By reducing exposure to willfulness claims, intellectual property opportunity information can flow more freely and thus transactions can be encouraged.

In one embodiment, an intellectual property lot can include an intellectual property right and a specified number of hours of the inventor's (or another expert's) time. Such a lot can be particularly attractive to a potential buyer because it includes both registered intellectual property and the inventor's know-how. In a further embodiment, the intellectual property lot can include the right to purchase additional hours of the inventor's time at a specified hourly rate.

In one embodiment, the listing fees for an intellectual property lot can be reduced based on a reserve price set by the seller. If a seller selects a promotional reserve price ($10,000, for example), the seller is entitled to lower listing fees. The seller would pay a higher listing fee is he selects any other reserve price.

To promote the intellectual property offerings, an intellectual property broker can publish a catalog highlighting the various lots available for sale. The catalog can contain, for example, descriptions of the patented technology, overviews of the copyright material, and reproductions of the brands/trademarks available for sale. The catalog can also include published expected value for one or more of the lots. In one embodiment, the catalog contains a listing of potential licensees for one or more of the intellectual property offerings. In a further embodiment, the catalog can contain a cross-referenced list of potential licensees for each lot organized by potential licensee.

In some circumstances, a registered bidder reviewing the intellectual property sale agreement in the data room may desire to propose alternate terms of sale to the seller. According to one embodiment of the present invention, a seller executes a second intellectual property sale agreement (or a second assignment document) having different terms and conditions. A winning bidder has the option to select either intellectual property sale agreement for his countersignature and/or recordation. Thus a first prospective bidder can request and potentially receive a desired change to the terms of sale without disrupting the diligence and bidding activities of a second prospective bidder content to operate under the original terms of sale. At the time of the auction, the terms of sale desired by any number have parties have been pre-negotiated, and the substantive details settled at the announcement of the winning bidder. Beneficially, the resulting marketplace is fair and transparent, and maintains complete consistency without rendering past diligence on existing transfer documents useless, while at the same time remaining flexible to accommodate requested changes to sale terms.

### EXAMPLES

Specific examples are presented below for exemplary purposes only. The examples are presented only to further enable one of skill in the art to perform the described methods. The presented examples should not be interpreted to limit the scope of the present invention in any manner.

### Example 1

A method for transacting intellectual property (IP) includes: receiving an executed document assigning an intellectual property right to an undefined party; holding the executed document in escrow; receiving one or more offers for the intellectual property right; determining a winning party based on the one or more received offers; and releasing the executed document to the winning party.

### Example 2

A method for protecting marketplace participants from willful infringement includes: receiving a first agreement from a first party, wherein the first agreement specifies that the first party will not use another party's participation in the marketplace as evidence of willful infringement; allowing the first party to participate in a marketplace transaction; and disallowing a second party to participate in the marketplace transaction, wherein the second party has not agreed to not use another party's participation in the marketplace as evidence of willful infringement.

### Example 3

A method for ensuring that intellectual property remains in salable condition includes: entering into a consignment agreement with a first seller, the consignment agreement authorizing a sale of an intellectual property right at auction; attempting to sell the intellectual property right at auction on a first auction date, wherein if the intellectual property right does not sell at auction, the consignment agreement obligates the first seller to maintain the intellectual property right in a salable condition for a period of time past the first auction date.

### Example 4

A system and method for screening intellectual property inventory for inclusion in a live or online IP auction includes: receiving such inventory through an online or electronic means; placing such inventory through an automated iP qualification system; accepting such inventory which qualifies under a set of specified criteria; and offering such accepted inventory for sale at live or online auction.

The qualification system may classify the intellectual property right according to a variety of factors. In the instance in which the intellectual property inventory includes a patent, the factors may include, for example, the extent of the patent's citation of prior art references, the international and/or U.S. technology class(es) and subclass(es) under which the patent was classified by a patent office (e.g., the U.S. Patent and Trademark Office), the number of years remaining in the patent term, the identity of the law firm that prosecuted the patent application that issued as the patent, and the number of claims in the patent. In one embodiment, the patent may be accepted for sale at the auction based on its classification as defined by such factors and whether the patent's classification meets the set of specified criteria. For example, the specified criteria may include that the patent have a given number of years remaining in the patent term or that the patent have been classified by a patent office under a particular U.S. technology class.

In one embodiment, the automated qualification system may include a rating system that provides a rating of the salability of the intellectual property inventory. In one embodiment, the inventory is accepted for sale at the auction if the inventory has a rating above a given threshold.

### Example 5

A system and method for filtering and accepting intellectual property submissions for consideration for sale in a live or online auction is achieved through an online submission form. An intellectual property submission including at least one intellectual property right for sale is downloaded to a database or some other electronic repository. Following the download, an automated qualification system can be used to classify the IP according to a variety of factors as described above. For example, the factors may include the existence and extent of potential buyers, number of years remaining in a patent term (in the case when the IP submitted includes a patent), technology area, or other measure of the value, quality and/or salability of the intellectual property right. The intellectual property right may be compared to a set of specified criteria, and the submission may be accepted for sale at auction if the intellectual property right meets the criteria. The qualification system may generate an “accepted or rejected” response to the submitting party.

A user can change the “rules” of the qualification system to weigh certain factors more than other factors, and to add or delete factors used by the system. The qualification system may generated an automated rating on each component of IP submitted or on an entire group of IP submitted. Such rating may include a numerical or letter score on the submitted EP. Regression analysis may be used to generate the rating. Methods and systems using such analysis for valuing IP rights are described in U.S. Pat. No. 6,556,992 to Barney et al., U.S. Patent Appl. Pub. No. 2004/0010393 to Barney, and U.S. Patent Appl. Pub. No. 2004/0220842 to Barney, the entire disclosures of which are hereby incorporated herein in their entirety by reference thereto. Tools and technology for valuing IP lights, such as patents, include, for example, Ocean Tomo's PatentRatings® software, developed by Ocean Tomo Patent Ratings, LLC.

Following the download of the submission, there may be an automated generation of potential buyers or licensors of the IP. Such generation may then be compared to a pre-set list of entities. Such comparison may require a pre-determined level of correlation for such submitted IP to be accepting into the live or online IP auction.

Submission through the online form may be achieved wirelessly. The submission may be patent numbers and/or free flowing text. A submission can be the result of a submitter choosing from a collection of pre-arranged options, such as IP specific diligence questions. The submitter may be required to enter username and password in order to provide a submission through the online form. The user may also be required to opt in/opt out of future marketing efforts. The submission may be date-stamped with the time and/or date, and a submission number may be assigned to each submission.

A report of the submissions may be generated. The submissions may be sorted in the report, and may be ranked against one another such as in order of the rating generated by the automated qualification system or based on some other factor or combination of factors.

The submission may include one or more of the following criteria: number of sellers/owners of the intellectual property, inclusion of “reservation price”, inclusion of “expected value”, seller's description to be included in an “event” catalog, and potential licensees or acquirers. The licensees or acquirers may be individual companies or entire industries. The criteria may be automatically uploaded into a designated template intended for the creation of the “event” catalog. The “event” catalog which may indicate the number of sellers to attend the “event”. The “event” may include a live IP auction.

### Example 6

A system and method for accepted sellers to complete and submit documents necessary for inclusion into a live or online intellectual property auction includes electronic means by which the accepted sellers complete such documents. Upon completion, an accepted seller submits such documents by clicking “send”, “submit” or other electronic or physical key or button intended to have the same functionality. Upon submitting, the system will automatically review such submission and return a message to the accepted seller specifying more information is needed, or that the submission has been accepted. The documents completed and submitted by the accepted seller may include a consignment agreement or other document intended to convey consignment of IP asset(s) to a receiving party. These documents may also include an IP sale agreement, one or more IP assignments, diligence questionnaires, and/or information questionnaires. The documents may include a “listing” of the IP to be sold. Informational requests and the like may also be completed and submitted by the accepted seller for use in the live or online IP auction.

### Example 7

A system and method for utilizing a centralized online data room or diligence platform for use in a live or online intellectual property auction includes a centralized repository of documents executed by sellers transferring IP rights to receiving parties. Provisioned access to the data room is given to potential buyers of the IP rights, whereby the potential buyers my review the executed documents. The potential buyers of the IP may bid on such IP rights in advance of, at, or following such IP which is offered for sale at a live IP auction. The data room or diligence platform may be used for a live or online auction.

### Example 8

A system and method for auctioning IP in a pre-negotiated transaction uses a centralized online diligence platform. The centralized platform has all documents necessary for the transfer of IP, and the documents are completed in advance of any IP diligence by potential buyers of the IP, whereby the completed documents are sufficient to effectuate transfer of the IP. The IP is offered to potential buyers at an auction, and the successful purchaser uses such completed documents to effectuate the final transfer of intellectual property.

The completed documents may be changed upon a potential buyer's request, and the changed document may be used to effectuate the final transfer of intellectual property. The completed documents may contain certain optional portions whereby the successful purchaser can choose which provisions they would like to include. For example, if a seller wanted to retain a back license, the completed documents may include five alternative provisions for the terms of the back license, whereby the successful purchaser may choose which provision for the back license they will agree to. The successful purchaser may be required to pay an additional amount in order to use certain provisions in the documents.

The centralized platform may contain multiple different options of documents which can all facilitate the transfer of IP, and the successful purchaser may select from the multiple different options of documents. A potential buyer may request an particular option of documents be changed, and the changed documents may be selected by the successful purchaser to effectuate the final transfer of intellectual property. Alternatively, the successful purchaser may agree which option of documents to use in advance of the auction. The successful purchaser may be required to pay for the ability to use a certain option of documents to effectuate the final transfer of intellectual property.

### Exemplary Computer System

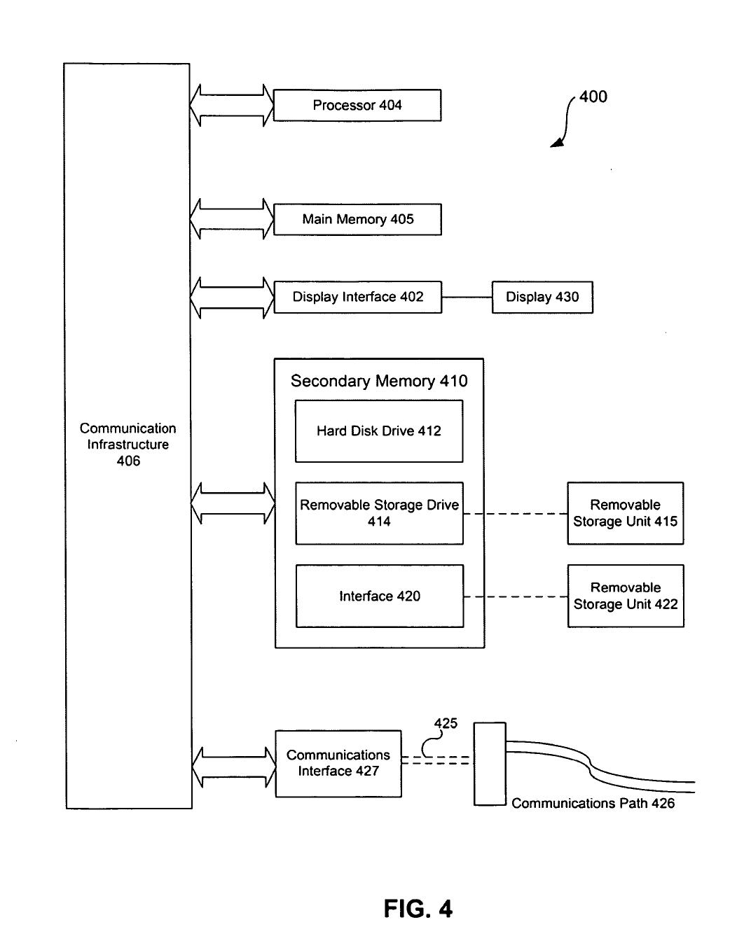

One or more computer systems may be used to carry out the methods described herein, such as the methods discussed in the Examples above. FIG. 4 illustrates an example computer system 400, in which the present invention can be implemented as computer-readable code. FIG. 4 illustrates an example computer system 400, in which the present invention can be implemented as computer-readable code. Various embodiments of the invention are described in terms of this example computer system 400. After reading this description, it will become apparent to a person skilled in the relevant art how to implement the invention using other computer systems and/or computer architectures.

FIG. 4 illustrates one or more processors, such as processor 404. Processor 404 can be a special purpose or a general purpose digital signal processor. The processor 404 is connected to a communications infrastructure 406 (for example, a bus or network). Various software implementations are described in terms of this exemplary computer system. After reading this description, it will become apparent to a person skilled in the relevant art how to implement the invention using other computer systems and/or computer architectures.

Computer system 400 can include a display interface 402 that forwards graphics, text, and other data from the communication infrastructure 406 (or from a frame buffer not shown) for display on a display unit 430. In one embodiment, display unit 430 may be configured to forward visual and/or auditory information to a user, and may be part of a stationary or mobile electronic device.

Computer system 400 also includes a main memory 405, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 415 in a well known manner. Removable storage unit 415, represents a floppy disk, magnetic tape, optical disk, etc. which is read by and written to by removable storage drive 414. As will be appreciated, the removable storage unit 415 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a PCMCIA slot and card, wired or wireless systems, etc. Software and data transferred via communications interface 424 are in the form of signals 425 which may be electronic, electromagnetic, optical, or other signals capable of being received by communications interface 424. These signals 425 are provided to communications interface 424 via a communications path 426. Communications path 426 carries signals 425 and may be implemented using wire or cable, fiber optics, a phone line, a cellular phone link, an RF link and other communications channels.

In this document, the terms “computer program medium” and “computer usable medium” are used to generally refer to media such as removable storage drive 414, a hard disk installed in hard disk drive 412, and signals 425. These computer program products are means for providing software to computer system 400.

Computer programs (also called computer control logic) are stored in main memory 405 and/or secondary memory 410. Computer programs may also be received via communications interface 424. Such computer programs, when executed, enable the computer system 400 to implement the present invention as discussed herein. In particular, the computer programs, when executed, enable the processor 404 to implement the processes of the present invention, such as the method(s) implemented as described above. These processes may be performed automatically, of invoice some form of manual intervention. Accordingly, such computer programs represent controllers of the computer system 400. Where the invention is implemented using software, the software may be stored in a computer program product and loaded into computer system 400 using removable storage drive(s) 414, hard drive 412 or communications interface 424.

The invention is also directed to computer products (also called computer program products) comprising software stored on any computer useable medium. Such software, when executed in one or more data processing device, causes the data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.). It is to be appreciated that the embodiments described herein can be implemented using software, hardware, firmware, or combinations thereof.

### CONCLUSION

While various embodiments of the presented method have been described, it should be understood that they have been presented by way of example, and not limitation. It will be apparent to a person skilled in the relevant art that various alternatives may be incorporated within the presented method without departing from the spirit and scope of the invention. For example, a similar process could also be used to auction exclusive or non-exclusive intellectual property licenses. Some patents are encumbered such that the owner does not have the right to transfer full title and assignment. In this case, it may be useful to auction a fully-paid up worldwide exclusive license. In one embodiment, the seller executes a binding license agreement which is held in escrow by an auction house. The rights to the license are offered in an auction, and the license is granted upon payment by the winning bidder. Thus a variety of intellectual property transactions can be conducted efficiently using an auction model.

Thus the present invention should not be limited by any of the above-described exemplary embodiments. Further, the Abstract and Summary of the Invention Sections are not intended to be limiting as to the scope of the present invention in any way. The breadth and scope of the present invention should be defined only in accordance with the following claims and their equivalents.

What is claimed is:

1. A method for transacting intellectual property, the method comprising:
receiving an executed document transferring an intellectual property right to an undefined party;
receiving one or more offers for the intellectual property right;
determining a winning party based on the one or more received offers; and
releasing the executed document to the winning party.

2. The method of claim 2, further comprising holding the executed document in escrow prior to releasing the executed document to the winning party.

3. The method of claim 1, wherein the executed document includes a commitment to transfer the intellectual property to the winning party, wherein the step of releasing the executed document to the winning party includes causing the transfer of the intellectual property to be completed in accordance with the commitment.

4. The method of claim 1, wherein the executed document is an intellectual property sale agreement, wherein the intellectual property sale agreement includes one or more documents and specifies terms of sale governing transfer of the intellectual property right.

5. The method of claim 1, further comprising placing the executed document in a data room for review by a potential acquirer prior to receiving one or more offers for the intellectual property right.

6. The method of claim 5, wherein the executed document specifies terms of sale governing transfer of the intellectual property right, the method further comprising:
receiving a request by the potential acquirer to change the terms of sale specified in the executed document; and
receiving a second executed document having the requested changed terms of sale,
wherein, if the potential acquirer is the winning party, then the step of releasing the executed document to the winning party includes releasing to the winning party the second executed document.

7. The method of claim 5, the method further comprising:
receiving at least a second executed document specifying terms of sale governing transfer of the intellectual property right, wherein the first executed document specifies terms of sale governing transfer of the intellectual property right that are different from the terms of sale of the second executed document,
wherein the step of releasing the executed document to the winning party includes releasing to the winning party either the first executed document or the second executed document based on the winning party's selection of the first or second executed documents.

8. The method of claim 5, wherein the data room is an on-line data room and includes information for the potential acquirer to conduct due diligence of the intellectual property right.

9. The method of claim 1, wherein the executed document contains one or more optional provisions that the winning party is permitted to choose to be included in the terms of sale of the intellectual property right.

10. The method of claim 5, wherein the step of receiving one or more offers includes receiving bids on the intellectual property right from one or more potential acquirers during a live auction or electronic auction.

11. The method of claim 10, wherein the one or more potential acquirers are registered bidders, the method further comprising receiving a registration document from an interested party whereby the interested party becomes a registered bidder.

12. A method for transacting intellectual property, the method comprising:
receiving a plurality of executed documents, each of the executed documents specifying different terms of sale governing transfer of an intellectual property right to an undefined party;
receiving one or more offers for the intellectual property right;
determining a winning party based on the one or more received offers; and
releasing one of the plurality of executed documents to the winning party.

13. The method of claim 12, wherein the step of releasing one of the plurality of executed documents to the winning party includes allowing the winning party to select the executed document that is released.

14. The method of claim 12, wherein the released executed document contains an optional one or more provisions that the winning party is permitted to choose to be included in the terms of sale of the intellectual property right.

15. The method of claim 14, further comprising requiring the winning party to pay an amount in addition to an amount paid for the intellectual property right in order to include the one or more optional provisions in the terms of sale.

16. The method of claim 12, further comprising placing the plurality of executed documents in a data room for review by a potential acquirer prior to the step of receiving one or more offers for the intellectual property right.

17. The method of claim 16, further comprising receiving a selection by the potential acquirer of one of the plurality of executed documents to be released if the potential acquirer is the winning party.

18. The method of claim 16, further comprising:
receiving a request by the potential acquirer to change the terms of sale specified in one of the plurality of executed documents; and
receiving a negotiated executed document having the requested changed terms of sale,
wherein if the potential acquirer is the winning party, then the step of releasing the executed document to the winning party includes releasing to the winning party the negotiated executed document.

19. The method of claim 18, further comprising if the potential acquirer is the winning party, then requiring the winning party to pay an amount for release of the negotiated executed document in addition to an amount paid for the intellectual property right.

20. A method for utilizing a centralized online data room for review of an intellectual property right for sale, comprising:
placing in the data room an executed document transferring the intellectual property right to an undefined party;
allowing a potential acquirer to access the data room, whereby the potential acquirer may review the executed document;
allowing the potential acquirer to bid on the intellectual property right in advance of, at, or following the offer for sale of the intellectual property right at a live or online intellectual property auction.

21. The method of claim 20, wherein the step of allowing a potential acquirer to access the data room includes allowing the potential acquirer to execute a non-disclosure agreement in order to review information available in the data room that is covered by the agreement.

22. The method of claim 20, further comprising receiving a request by the potential buyer for a private due diligence meeting with a seller of the intellectual property right.

23. The method of claim 20, wherein the data room includes information for the potential acquirer to conduct due diligence review of the intellectual property right.

24. The method of claim 23, wherein the information includes a completed intellectual property diligence questionnaire submitted by a seller of the intellectual property right.

25. The method of claim 20, further comprising placing in the data room a plurality of executed documents transferring a plurality of intellectual property rights.

26. The method of claim 25, wherein the plurality of intellectual property rights are offered for sale together in a lot, wherein the step of allowing the potential acquirer to bid on the intellectual property includes allowing the potential acquirer to bid on the lot.

27. The method of claim 20, further comprising requiring the potential acquirer to register in order to access the data room.

28. A method for protecting participants in an intellectual property marketplace from claims of willful infringement of an intellectual property right, the method comprising:
receiving an agreement from a first party, wherein the agreement includes a covenant that the first party will not use another party's participation in the marketplace as evidence in a judicial or an administrative proceeding;
allowing the first party to participate in a marketplace transaction; and
disallowing a second party to participate in the marketplace transaction, wherein the second party has not agreed to not use another party's participation in the marketplace as evidence in a judicial or an administrative proceeding.

29. The method of claim 28, wherein the covenant by the first party includes a covenant that the first party will not use another party's participation in the marketplace as evidence of willful infringement.

30. A method for ensuring that intellectual property remains in salable condition, the method comprising:
entering into a consignment agreement with a seller, the consignment agreement authorizing a sale of an intellectual property right at auction;
offering for sale the intellectual property right at auction on an auction date, wherein if the intellectual property right does not sell at auction, the consignment agreement obligates the seller to maintain the intellectual property right in a salable condition for a period of time past the auction date.

31. The method of claim 30, wherein the consignment agreement authorizes a sale of a plurality of intellectual property rights.

32. A method for accepting intellectual property submissions through an online submission form for consideration for sale in an intellectual property auction, comprising:
receiving a submission including an intellectual property right for sale;
having the submission download to an electronic repository; and
using an automated qualification system to classify the intellectual property right.

33. The method of claim 32, further comprising:
accepting to sell the intellectual property right at the auction if the intellectual property right has a classification given by the qualification system that meets a pre-determined set of criteria; and
offering the accepted intellectual property right for sale at the auction.

34. The method of claim 33, wherein the pre-determined set of criteria includes a given number of potential acquirers of the intellectual property right.

35. The method of claim 32, wherein the automated qualification system provides a rating of the intellectual property right, the method further comprising:
accepting to sell the intellectual property right at the auction if the intellectual property right has a rating above a given threshold; and
offering the accepted intellectual property right for sale at the auction.

36. The method of claim 35, wherein the step of receiving a submission includes receiving a submission for a group of intellectual property rights for sale, wherein the qualification system provides a single rating for the group of intellectual property rights.

37. The method of claim 32, wherein the submission further includes one or more identifications of: (i) a total number of owners of the intellectual property right, (ii) a reserve price for the intellectual property right if offered for sale at the auction, (iii) a value of the intellectual property right, (iv) a description of the intellectual property right; and (v) potential acquirers.

38. The method of claim 37, further comprising having the one or more identifications automatically formatted in a template used to create an event catalog for the auction.

39. The method of claim 32, wherein the online submission form includes an intellectual property diligence questionnaire, wherein the submission includes responses to the intellectual property diligence questionnaire.

40. The method of claim 32, further comprising:
receiving a plurality of submissions, each submission including respective intellectual property rights for sale; and
generating a report that sets forth a classification of each intellectual property right given by the qualification system.

41. The method of claim 32, wherein the submission further includes a consignment agreement authorizing a sale of an intellectual property right at the auction.

42. The method of claim 32, wherein the submission further includes an executed document transferring an intellectual property right to an undefined party.
